(19) United States
(12) Patent Application Publication
(10) Pub. No.: US 2023/0334438 A1
(43) Pub. Date: Oct. 19, 2023

(54) Vehicle Damage Assessment and Repair Process

(71) Applicant: Tractable Ltd, London (GB)

(72) Inventor: Marcel HORSTMANN, London (GB)

(21) Appl. No.: 18/303,041

(22) Filed: Apr. 19, 2023

Related U.S. Application Data
(60) Provisional application No. 63/363,194, filed on Apr. 19, 2022.

(51) Int. Cl. G06Q 10/20; G06Q 10/1093; G06Q 30/0283

(52) U.S. Cl. CPC G06Q 10/20; G06Q 10/1095; G06Q 30/0283

(57) ABSTRACT

An artificial intelligence (AI) system is configured to receive a series of images of a vehicle from one or more viewpoints, identify, for at least a first image from the series of images using a machine learning model, one or more parts of the vehicle captured in the image using a first classifier for identifying parts of the vehicle and identifying, for at least the first image, that one of the parts of the one or more parts of the vehicle incurred damage.

### PRIORITY/INCORPORATION BY REFERENCE

This application claims priority to U.S. Provisional Application 63/363,194 filed on Apr. 19, 2022 and entitled “Vehicle Damage Assessment and Repair Process,” the entirety of which is incorporated herein by reference.

### BACKGROUND

Existing systems may include a server receiving images of a damaged vehicle and executing a series of machine learning models for determining, for example, which part of the vehicle (e.g., front bumper, windshield, etc.) has been captured in the image, what type of damage the vehicle part has suffered, the extent of the damage, etc. In some systems, a mobile application, e.g., on a user device including a camera, can be used to capture the images of the vehicle and perform some or all of the classifying steps necessary to provide the damage assessment, e.g., via a web-based application hosted on a server and accessed over a radio access network.

After the damage suffered by the vehicle is assessed by the system, steps can be taken to repair the vehicle. First, the damage can be re-assessed by one or multiple repair shops (if, for example, the vehicle owner or insurer solicits multiple repair estimates), and the initial damage assessment performed by the system can be updated based on the findings of the repair shop. In some scenarios, internal damage can be identified by the repair shop that was not visible in the images. Replacement parts can be ordered, and a selected repair shop (or multiple shops) can perform the vehicle repairs. Currently, this process can be cumbersome for the vehicle owner and/or the insurer. For example, a replacement part can take multiple days or even weeks to arrive at the repair shop, and, depending on the availability of the repair shop technicians to perform the repairs, the repair work can take multiple additional days or weeks before completion. In some scenarios, a further repair shop different from the selected repair shop could have completed the repairs in significantly less time and/or with significantly less cost than the selected repair shop.

### SUMMARY

Some exemplary embodiments are related to a method for receiving a series of images of a vehicle from one or more viewpoints, identifying, for at least a first image from the series of images using a machine learning model, one or more parts of the vehicle captured in the image using a first classifier for identifying parts of the vehicle and identifying, for at least the first image, that one of the parts of the one or more parts of the vehicle incurred damage.

Other exemplary embodiments are related to a method for when the one of the parts of the vehicle incurred damage indicative of a repair operation for the one of the parts comprising replacement of the one of the parts, identifying, using the machine learning model, additional features of the one of the parts of the vehicle, matching the one of the parts and the additional features to a list of available parts provided by a vendor, determining a replacement part in the list of available parts that corresponds to the one of the parts and ordering the replacement part from the vendor.

Still further additional embodiments are related to a method for receiving repair shop information comprising an availability and capabilities of each of a plurality of repair shops, selecting one of the plurality of repair shops and scheduling repairs for the vehicle at the selected one of the plurality of repair shops.

Additional exemplary embodiments are related to a system having a memory comprising a series of images of a vehicle from one or more viewpoints. The system also has a processor configured to identify, for at least a first image from the series of images using a machine learning model, one or more parts of the vehicle captured in the image using a first classifier for identifying parts of the vehicle, identify, for at least the first image, that one of the parts of the one or more parts of the vehicle incurred damage, when the one of the parts of the vehicle incurred damage indicative of a repair operation for the one of the parts comprising replacement of the one of the parts, identify, using the machine learning model, additional features of the one of the parts of the vehicle, match the one of the parts and the additional features to a list of available parts provided by a vendor, determine a replacement part in the list of available parts that corresponds to the one of the parts and order the replacement part from the vendor.

### BRIEF DESCRIPTION OF THE DRAWINGS

FIG. 1 shows an exemplary user device for providing a real-time damage estimate and a streamlined repair process using an artificial intelligence (AI) based application according to various exemplary embodiments described herein.

FIG. 2 shows an exemplary AI system including the user device in communication with a damage estimation service via a network, wherein the damage estimation service hosts the AI-based application that is executed at the user device according to various exemplary embodiments described herein.

FIG. 3 shows a method for providing a real-time damage estimate and a streamlined repair process using an artificial intelligence (AI) based application according to various exemplary embodiments described herein.

FIG. 4 shows an exemplary flow for the AI system to determine an internal damage estimate according to various exemplary embodiments described herein.

### DETAILED DESCRIPTION

The exemplary embodiments may be further understood with reference to the following description and the related appended drawings, wherein like elements are provided with the same reference numerals. The exemplary embodiments are related to an image-based artificial intelligence (AI) system may be used to provide a rapid damage estimate for a vehicle and facilitate the subsequent repair of the vehicle. The AI system may operate by receiving images of a damaged vehicle, classifying the damage, and providing an assessment of the damage, e.g., an estimated repair cost, to a user without involving a professional claims adjuster.

Throughout this disclosure the term “images” should be understood to refer to image data that is collected in any manner. In one example, the images may refer to one or more digital photographs. In another example, the images may be a series of one or more frames of a digital video. Additionally, images may include a combination of digital photographs and digital videos. Those skilled in the art will understand any other manners of collecting image data.

In addition, throughout this disclosure it will be described that various operations are performed by various components within a system (e.g., user device 100, damage estimation service 210, etc.). It should be understood that the operations or functionality described for a particular component is not limited to that component, i.e., the operations or functionality may be performed by a different component in a distributed system. The described system is only exemplary and there may be other implementations of a system that may perform the operations as described herein. For example, each of the network components described herein may be implemented in one or more of a server device, a virtual machine, a cloud computing environment, etc. Thus, throughout this description, it may be described that an operation is performed by the “system,” and it should be understood that this refers to the operation being performed by any of the described components or other equivalent components.

Throughout this description, it may be described that certain operations are performed by one or more machine learning models or a series of machine learning models. Those skilled in the art will understand that there are many different types of machine learning models. For example, the exemplary machine learning models described herein may include visual and non-visual algorithms. Furthermore, the exemplary machine learning models may include classifiers and/or regression models. Those skilled in the art will understand that, in general, a classifier model may be used to determine a probability that a particular outcome will occur (e.g., an 80% chance that a part of a vehicle should be replaced rather than repaired). While a regression model may provide a value (e.g., repairing a part of a vehicle will require 7.5 labor hours). Other examples of machine learning models may include multitask learning models (MTL) that can perform both classification, regression and other tasks. The resulting AI system described below may include some or all of the above machine learning components or any other type of machine learning model that may be applied to determine the expected outcome of the AI system. It should be understood that any reference to one or more (or a series) of machine learning models may refer to a single machine learning model or a group of machine learning models. In addition, it should also be understood that the machine learning models described as performing different operations may be the same machine learning model or different machine learning models.

In some exemplary embodiments, it may be described that the AI may make evaluations by comparing images of damaged property versus images of undamaged property. However, it should be understood that the exemplary embodiments do not require such a comparison. In other exemplary embodiments, the AI may make evaluations without directly comparing an image of damaged property with images of undamaged property. That is, the machine learning models described herein may perform property evaluations for damaged property without regard to images of the undamaged property.

As described above, existing systems may have drawbacks such as being cumbersome for the vehicle owner and/or the insurer. According to various exemplary embodiments described herein, an AI-based vehicle damage assessment system can include functionality to streamline the repair process for a damaged vehicle. In one aspect, the AI-based image analysis is enhanced to include an identification of potential internal and non-body damage. Multiple parts of the vehicle can be analyzed by a machine learning model or series of machine learning models and a likelihood of additional damage can be assessed at an earlier stage of the repair process. In another aspect, the AI-based image analysis of the vehicle is enhanced to include an identification of specific features of the damaged vehicle part based on an AI model that is agnostic to the make, model, or year of the part. Key features of a vehicle part or panel (e.g., a “normalized” part) are identified, relative to other versions of the same part that include different features, to quickly determine the replacement part that is needed.

In further aspects, the AI system can interface with external services to retrieve vehicle part availability information to identify vehicle parts, vendors carrying replacement parts and, in one embodiment, automatically order the replacement parts necessary to complete the repairs. The AI system can additionally retrieve repair shop information and match the necessary vehicle repairs to the work planning tools of these shops, including, e.g., repair capabilities, technician availability, etc., to provide to the customer an optimal location to conduct the repairs.

By performing these steps at an earliest possible time, e.g., directly after the damage is incurred, the exemplary AI system can minimize the time to completion of the repairs and/or minimize the cost of the assessment and/or repair process for interested parties including the vehicle owner and/or an insurer.

As will be described in further detail below, there are many use cases and each use case may include one or more different entities. For example, as will be described in the examples below, in some instances the entity that uses the AI system (or receives results from the AI system) may be the owner/operator of the vehicle, an insurance company, a repair shop, a vehicle parts retailer, etc. Thus, it should be understood that the information that is provided by the AI system may be accessed and used by a variety of entities and is not limited to any particular entity. In addition, the application described herein may be branded by any entity within the process, such as an insurance company, retail parts chain, other third part, etc.

In addition, while a damaged vehicle and repair is typically considered in the context of a vehicle accident, the exemplary embodiments are not limited to an accident scenario. For example, certain damage to a vehicle (e.g., rust, dents, dings, paint fading, etc.) may be due to normal wear and tear that an owner would like to repair. This type of damage does not prevent the owner from safely operating the vehicle and the associated repairs may be considered to be elective repairs. The exemplary embodiments may be used in this type of scenario because the owner may not want their vehicle to be sitting at a repair shop that is waiting (days or weeks) for a part or a technician to be available for the repair. The AI system may allow the repair shop and the owner to coordinate the repair such that the owner will only take the vehicle to the repair shop when it is completely ready to be repaired. It should also be noted that some accident scenarios may also allow the vehicle to continue to be driven safely and thus, this type of scenario may also be applicable to vehicles that were damaged by accident.

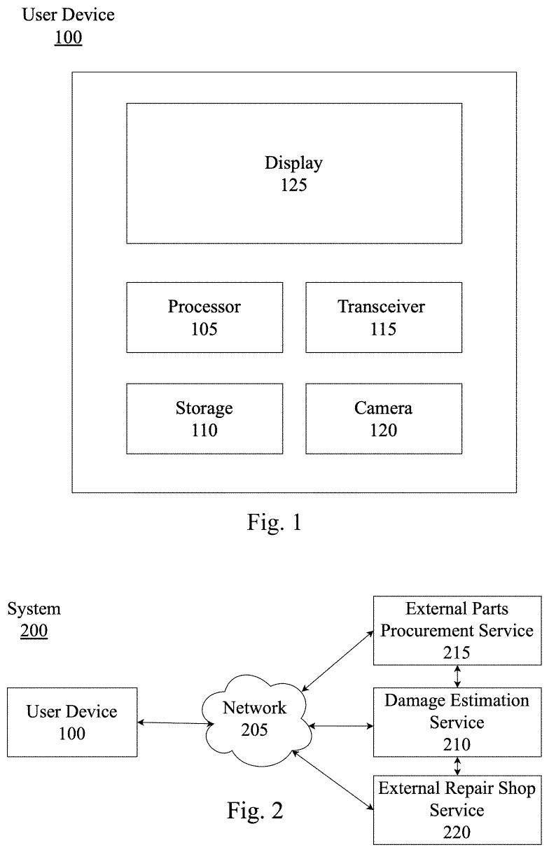

FIG. 1 shows an exemplary user device 100 for providing a real-time damage estimate and a streamlined repair process using an artificial intelligence (AI) based application according to various exemplary embodiments described herein. The user device 100 includes a processor 105 for executing the AI-based application. The AI-based application may be, in one embodiment, a web-based application hosted on a server and accessed over a network, e.g., a radio access network, via a transceiver 115 or some other communications interface.

FIG. 2 shows an exemplary AI system 200 including the user device 100 in communication with a damage estimation service 210 via a network 205, wherein the damage estimation service 210 hosts the AI-based application that is executed at the user device 100. However, in other embodiments, the user device 100 may store some or all of the application software at a storage 110 of the user device 100. For example, in some web-based applications, a user device 100 may store a part of the application software locally at the user device 100, while the majority of the processing is performed at the remote server. In another example, the user device 100 may store the entire application in the storage 110 of the user device 100, however, this may require significantly more storage capacity relative to the web-based application. Similarly, certain classifying steps can be performed at the user device, including, e.g., identifying which parts of the vehicle are seen in the image(s), while further classifying steps can be performed at the server. Those skilled in the art will understand that a classifying AI system executed on one or more servers can be designed to be more robust than a classifying AI system executed on a mobile device.

The user device 100 and/or the damage estimation service 210 can additionally communicate with an external parts procurement service 215 and/or an external repair shop service 220, to be described in greater detail below.

The user device 100 further includes a camera 120 for capturing images and a display 125 for displaying the application interface and/or images with information overlaid thereon, e.g., indicators for guiding the user to capture high quality images for damage assessment purposes. The user device 100 may be any device that has the hardware and/or software to perform the functions described herein. In one example, the user device 100 may be a smartphone including the camera 120 located on a side (e.g., back) of the user device 100 opposite the side (e.g., front) on which the display 125 is located. The display 125 may be, for example, a touch screen for receiving user inputs in addition to displaying the images and/or other information via the web-based application.

The application includes a series of machine learning models for determining various types of information about the vehicle. For example, a first machine learning model identifies which part of the vehicle (e.g., front bumper, windshield, etc.) has been captured in the image, a second machine learning model identifies what type of damage the vehicle part has suffered, the extent of the damage, etc. Alternatively, a single machine learning model could identify the part of the vehicle, and whether it has been damaged. Additionally, these machine learning models can determine what repair operations would be required with respect to the damage of the parts that are damaged. In existing systems, the vehicle analysis does not include an assessment of internal damage that cannot be directly determined from images of a particular part.

In one exemplary embodiment, an additional machine learning model can identify the potential for internal and/or non-body damage based on an analysis of multiple images of multiple vehicle parts. This assessment can be beneficially used at an early stage of the damage assessment process (e.g., prior to inspection by a repair shop), so that an interested party (including, e.g., the vehicle owner and/or an insurer) can quickly determine whether the damage is likely to be repairable within reasonable cost or if the vehicle should be totaled. As used herein, the term “totaled” refers to a vehicle suffering damage so significant that the cost of repair exceeds a threshold based on the replacement value of the vehicle. The assessed damage type can be associated with a probability or confidence value that the damage was, in fact, incurred. For example, if the system can determine with a high degree of confidence that significant internal damage was suffered, then the process can include the assumption that the vehicle is totaled. In some exemplary embodiments, a determination by the AI that the vehicle is totaled may trigger an action by the insurer. For example, the likelihood of this internal damage could be communicated to a user, such as a repair shop so they are aware that the existence of this damage should be further inspected. In another example, this may trigger the insurer to immediately send an adjuster to visually inspect the vehicle to confirm the AI determination so that no additional time or expense is incurred for the vehicle, trigger a salvage operation by the insurer, notify the vehicle owner that a vehicle replacement process has been triggered, etc.

Additionally, the AI system, based on historical or other data related to similar damage to internal systems, can provide an estimate of the total cost, or range of costs, to repair the system. These assessments could be for total cost of the repair, or may be broken down by labor hour, part, and other assessments. The range can be based on, for example, preselected confidence values, percentage differences (such as +/−10%), or absolute values.

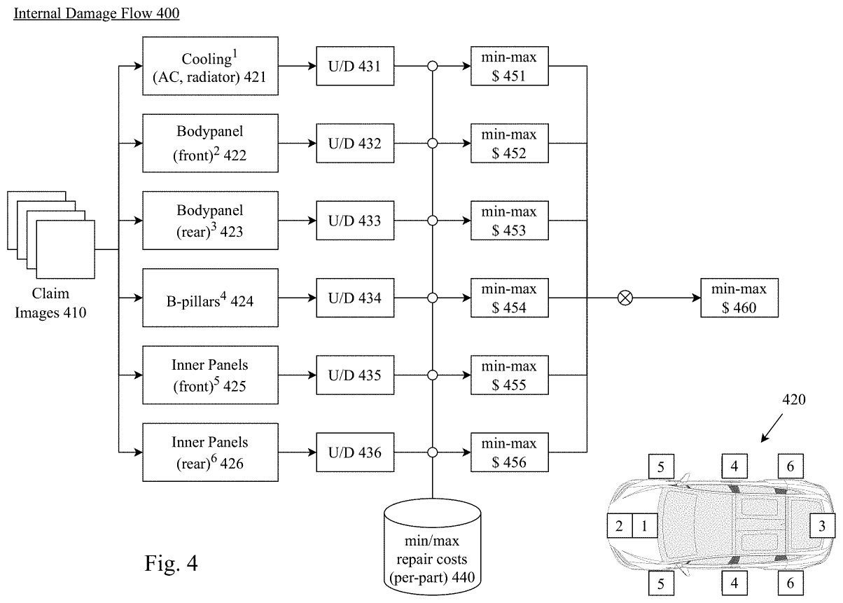

FIG. 4 shows an exemplary flow 400 for the AI system to determine an internal damage estimate according to various exemplary embodiments described herein. In the flow 400, the images 410 of the vehicle may be sorted according to a location of a vehicle that is indicative of a type of internal damage. In the example of FIG. 4, there are six categories 421-426 showing the general locations labeled 1-6 as also illustrated on the exploded view 420 of the vehicle. It should be understood that the use of six (6) categories or locations is only exemplary and depending on the type of vehicle, there may be a different number of categories, e.g., a traditional gas powered vehicle may have a different number of categories than an electric vehicle (EV). These categorized images may be then evaluated using an appropriate machine learning model 431-436, respectively, to determine whether the images are indicative of any internal damage. In this example, the machine learning models are implementing unsupervised deep learning (U/D) techniques, but other machine learning techniques m ay be employed. Once internal damage has been determined, the AI system may determine from a database 440 (or any other storage mechanism) an expected maximum and/or minimum value of repairing any identified damaged internal parts. This maximum/minimum value for each of the internal damage categories/locations are shown as minimum/maximum 451-456. These values may then be summed to determine the total minimum/maximum cost 460 of repairing the determined internal damage to the vehicle. As will be described in greater detail below, the total minimum/maximum cost 460 may be used, for example, by the AI system when making an evaluation as to whether a vehicle is totaled.

As the internal damage assessment is based on damage that may not be visible in the images, but is inferred from them, the level of specificity of the damage for internal damage may be lower than the specificity of damage of the externally visible portion. For example, the machine learning models (e.g., classifiers) could identify what specific component of a larger external system was damaged, such as front left halogen lamp, whereas the machine learning models for the internal system may only determine that there is likely severe damage to the coolant system. This leads to different levels of accuracy with respect to internal and external damage, and an increased need for additional inspections to occur with respect to potential internal damages.

On the other hand, if the AI system can determine with a high degree of confidence that significant internal damage was not suffered (and that any other determined damage has a sufficiently low cost for repair), then the process can include the assumption that the vehicle is not totaled and that the repair process should proceed. It will be understood by those skilled in the art that varying standards can be applied, either automatically or by a professional reviewing the information, for the assessment of whether the vehicle is totaled.

The AI system can be configured to make this total loss vs. repairable decision by a number of different formulas. For example, if the estimate of the visible external damage exceeds the threshold value for a vehicle to be determined to be totaled, then this recommendation can be applied without consideration of the internal damage. If the visible external damage does not exceed that threshold, then the external damage estimate can be combined with the lower end of the range of predicted internal damage, and if it exceeds the threshold a totaled determination may be made. Finally, if neither of the prior results in a totaled decision, the external damage could be combined with the midpoint, or alternatively with the high end, of the damage range, and compared to a threshold value, which may be higher than the threshold value used in the prior steps. These values can be optimized to help steer the initial decisions regarding the routing of the car in an optimal manner. A number of factors may be considered in making this optimization including car owner satisfaction, non-reimbursed expenses for repair shops, added costs to insurers (such as payment of storage fees for cars at a repair shop that are determined to be totaled), etc. Car owner satisfaction can be impacted by the time for the insurer to make a total loss determination and the time for the car to be repaired. For example, an insured might prefer to know immediately that their car was totaled so they can purchase a replacement vehicle.

In some exemplary embodiments, the AI system may make a decision to total the vehicle. For example, the AI system, using the machine learning models, may estimate the external damage and the internal damage in any of the various manners as described herein. The AI system may then apply logic based on the internal/external damage estimates. For example, a first decision may be whether the vehicle has experienced any internal damage. If the AI system has determined that the vehicle has experienced internal damage, the AI system may then determine a values that is the sum of the external damage value and the minimum internal damage. As described herein, in a typical scenario, the estimate of the external damage has a higher confidence value than the estimate of the internal value because the external estimate is based on the information that is visible in the images while the internal damage is generally inferred from the images. Thus, the estimated value of the internal damage may include a range of values from a minimum value to a maximum value. In this example, the minimum internal damage value is being added to the external damage value. If this sum of damage values is greater than the value of the vehicle minus the salvage value of the vehicle, the AI system may determine that the vehicle is a total loss. It should be understood that the AI system may have data or access to data to determine the value of the vehicle and the salvage value, (e.g., third party data sources such as Kelly Blue Book, etc.). On the other hand, if the sum of the external damage and the minimum internal value is less than the vehicle value and the sum of the external damage and the maximum internal value is greater than the value of the vehicle minus the salvage value of the vehicle, the AI system may determine that further human intervention is required to make a total decision.

To continue with the example, if the AI system has determined that the vehicle has not experienced internal damage, the AI system may determine that if the value of the external damage is greater than the value of the vehicle minus the salvage value of the vehicle, the vehicle is a total loss. On the other hand, if the if the value of the external damage is less than the value of the vehicle minus the salvage value of the vehicle, the vehicle is repairable. As described herein, these decisions on whether a vehicle is totaled, is repairable or needs to be further evaluated by a human may be made early in the claims process to cure the issues that were described above. It should be understood that the above formulas (e.g., comparison of values) for determining whether a vehicle is totaled are only exemplary and other comparisons or factors may be used by the AI system when making the determination.

Internal or non-body damage can include, e.g., frame misalignment, damaged suspension, steering column damage, or engine damage. Engine damage can be inferred from factors such as, e.g., massive hood damage, leaking fluids, whether the vehicle will start, engine noise, etc. Frame misalignment can be inferred from factors such as, e.g., the wheels facing in inconsistent directions, angle of steering column, etc. In many scenarios, these types of damage are not determinable from an analysis of only a single vehicle part. Thus, the machine learning models including any classifier(s) or regression models as described herein are designed to receive multiple images of multiple vehicle parts and determine from the totality of the images whether it is likely that the internal damage was suffered. In addition, machine learning models based on audio recordings of the vehicle could be used as well. The machine learning models may also include certain other non-visual inputs, such as airbag deployment, information on whether vehicle will start or is drivable, and leaking fluids seen at place of accident (especially where different from the location of the images being captured).

The machine learning models for making the totaled determination may be trained, for example, using images of previously totaled and non-totaled vehicles. For example, the machine learning models may be trained using images of vehicles having a certain type of exterior damage such as hood damage and whether the hood damage resulted in a vehicle being totaled or not totaled. In another example, the machine learning models may be trained based on the fluids that are seen to be leaking in exterior images of totaled and non-totaled vehicles. This training may be specific to a particular make or model of vehicle or be vehicle agnostic. It should also be understood that the machine learning models may take multiple parts or indicators into account when making the totaled determination.

In some exemplary embodiments, the probability of internal damage may be considered when choosing the repair shop. For example, if the estimated cost of repairing the internal damage is above a threshold (e.g., a high likelihood of frame damage), the repairs shop selection may be influenced by this determination (e.g., the vehicle should go to a repair shop that is competent for such repairs. On the other hand, if there is a low likelihood of internal damage, this may not be considered when selecting a repair shop. It should be understood that this probability of internal damage may influence both an automatic selection of a repair shop (e.g., by the AI system) or a manual selection of the repair shop. For example, when the AI system is selecting the repair shop, the AI system may factor in the internal damage probability when making the selection. When the selection is manual, the AI system may display different repair shops in order to a user. This order may be influenced by the capabilities of the repair shops and the potential repairs needed by the vehicle. Thus, if there is a high probability of internal damage, the AI system may bias those repair shops that are competent to repair the internal damage to the top of the listing for the user.

In another aspect of these exemplary embodiments, additional machine learning models can identify key features of damaged vehicle parts to distinguish between different versions of a same part. Similar to above, this assessment can be beneficially used at an early stage of the damage assessment process (e.g., prior to inspection by a repair shop), so that an interested party (including, e.g., the vehicle owner, an insurer, and/or a repair shop) can quickly order a replacement part for the vehicle. Alternatively, the AI system could automatically order the replacement parts for a vehicle to further streamline the repair system. This ordering of a replacement part can include not just a single part, but additional parts associated with replacement of the damaged part. For example, if replacement of a part requires replacement of a specific bolt, the bolt can be included in the order of the replacement part. The specific parts chosen may be chosen from OEM, aftermarket replacement, salvage or other equivalent parts, and this can be done based on a selection by a user, or automatically based on preferences set by a user. This could include preferences set on a general level, or down to a specific part level. For example, OEM parts might always be chosen as long as not 10% more than an alternative part. In another example, for certain makes of cars only OEM bumpers are chosen.

As used herein, the term “normalized” is used with respect to a vehicle part to refer to a broad classification or type of part. For example, a bumper, a side view mirror or a hood is a normalized part. However, within these normalized part classifications, a specific part can include additional features. For example, for a given vehicle type, a bumper may be a standard bumper without any additional features, a split bumper, a bumper with additional features such as fog lamps, sensors, or other features. In another example, the part can be painted a certain color, can be made of plastic or chrome, etc. When it is determined that damage was suffered by a vehicle part, such as the bumper, it can be beneficial to further determine specific features of the damaged part so that a replacement part including these features can be quickly procured. While the above example is described with respect to a vehicle bumper, it will be understood that the same principle applies to other vehicle parts.

The machine learning models used to determine key features of a normalized part can be agnostic to the specific vehicle (e.g., the make, model and year of the vehicle). The specific vehicle characteristics can be received or determined by the AI system in other ways, e.g., based on some manual input, based on a different machine learning model, or from information stored by the AI system and/or the user device. Thus, the machine learning models used to determine the key features can perform the classification regardless of the vehicle being analyzed. These machine learning models can be trained based on visual characteristics of these features that can be found across multiple different vehicle types.

In some embodiments, once the damaged part is identified, the specific replacement part may be determined using specific information about the vehicle that is retrieved from external data sources. For example, based on a vehicle identification number (VIN) the AI system may access a specific build sheet for the vehicle that includes an identification of the bumper that is specific to the vehicle. However, this requires access to the build sheet or similar information about the vehicle from external data sources that may or may not be available.

In contrast, the machine learning models that are trained using the key features described above is able to determine the specific part for the damaged vehicle without reference to other data. To carry through with the above example of a bumper, the machine learning model may be trained using one or more key features to identify the bumper for the individual vehicle as a split bumper using only the provided images. It should be understood that this does not preclude the classifier from receiving information in addition to the images, e.g., a manual input of year, make, model, etc. However, this still reduces the need for external data sources. Thus, the machine learning model is able to determine the specific part for the damaged vehicle without reference to other external data, such as the specific build information for a specific vehicle based on its VIN.

After identification, the damage assessment and the key features of the parts suffering the damage can be provided to additional modules of the AI system to facilitate the repair of the vehicle. The user device 100 executing the image-based AI machine learning models described above (e.g., hosted at the damage estimation service 210) can additionally communicate with an external parts procurement service 215 and/or an external repair shop service 220 to execute additional logic to order replacement parts and/or schedule repairs with an available repair shop. It should be understood that this logic, to be described in further detail below, can be executed at the user device 100, at the damage estimation service 210, etc. It should be further understood that the parts procurement service 215 and the repair shop service 220 can be combined within a single service or integrated with the damage estimation service 210. Those skilled in the art will ascertain that various services exist that can provide up-to-date information about parts availability and repair shop availability, and these services can have varying levels of data granularity.

In one aspect of these exemplary embodiments, the AI system (user device 100 and/or damage estimation service 210) can access the external parts procurement service 215 to determine the availability of replacement parts from various parts vendors. In another aspect, the AI system can access the external repair shop service 220 to determine the availability of repair shops and repair shop personnel that are able to perform the repairs. Information from these respective services 215, 220 can be used in various orders of operation to order replacement parts and to schedule the repair of the vehicle.

In one exemplary use case, a national repair shop chain branded application that implements the exemplary embodiments could allow a customer to take the video. Based on the information derived from the video, the chain may then direct the customer to the best location (e.g., based on proximity and availability of personnel), pre-order the parts, and inform the customer when to bring the vehicle to the shop. For example, if the vehicle is safely drivable, this process may minimize loss of the vehicle to the customer and reduce the need and length for loaner/rental vehicles.

The external parts procurement service 215 can include databases of parts including general identifying features for the part (e.g., make, model, year) and additional specific features for the part (e.g., whether sensors are included on the part). Based on the machine learning models described above, the AI system has knowledge of these features for the damaged part. This information can be mapped to the information provided by the parts procurement service 215 (e.g., a catalog of parts maintained for one or more vendors) to match the damaged part to a replacement part. In one embodiment, a specific naming convention for part features can be used by the AI system to map the identified features to the parts catalog. As described above, in one beneficial aspect of the exemplary AI system, more detailed parts data (e.g., specific build sheets for specific vehicles) is not required to identify the replacement part. The parts procurement service 215 can further determine the availability of the part from one or more vendors. Certain vendors can provide this information to the parts procurement service 215 in various ways, e.g., by integrating an internal parts tracking system of the vendor with the parts procurement service 215. Those skilled in the art will understand that the parts procurement service 215 can provide parts availability information for any number of vendors and is limited only by access to this information from specific vendors. If a large number of vendors are integrated with the parts procurement service 215, then multiple vendors can potentially be identified as vendors that can provide the replacement part.

The various parts vendors can be further associated with information related to the shipment of these parts to repair shops. For example, a current geographical location of the part, shipping practices used by the vendor, and other information can be used to approximate the amount of time it would take for the replacement part to arrive at a particular repair shop.

To accomplish the above, a mapping between the identified vehicle part and the parts vendors may be incorporated or trained into the AI system. To again carry through with the above example of the machine learning models identifying a split bumper as the damaged part. The system may be trained to identify the split bumper based on part descriptions from parts databases/catalogs of various parts vendors. A simple case may be considered where the parts database specifically identifies the part based on make/model/year with the description “split bumper.” However, this may not always be the case. For example, the parts may be identified using different nomenclature, e.g., “bumper type II.” This information may be mapped in the AI system so that the AT system understands that “bumper type II” is a split bumper as identified by the machine learning models. Again, while this mapping has been described with reference to a bumper, it will be understood that the mapping may be extended to any vehicle part.

The external repair shop service 220 can include databases of repair shops in association with characteristics of the repair shops. For example, these characteristics can include: a geographical location; hours of business; scheduling availability of certain tools used by the repair shop with respect to certain repair operations; scheduling availability of certain technicians employed by the repair shop; assessment of the expertise of a repair shop with respect to various repair operations, and other characteristics. The information regarding repair operations (including, for example, tools and expertise) may be at a car make, model, or even year level, or may be independent of any of these. These repair shop characteristics can be leveraged by the AI system to determine an optimal repair shop to conduct the repairs to the damaged vehicle. For example, if a specific tool is needed to perform a repair operation identified by the AI System, then repair shops that have that specific tool could be identified.

In one example, it may be determined by the AI system that the vehicle requires additional examination prior to initiating the repair process, e.g., to determine whether the vehicle is totaled. In this example, the repair shop service 220 can be accessed to determine one or more repair shops in the vicinity of the damaged car that are currently equipped and available to, e.g., tow the vehicle to the repair shop and inspect the vehicle for damage. In another example, it may be determined by the AI system that the vehicle requires special repairs requiring special tools and/or expertise. In this example, the repair shop service 220 can be accessed to determine one or more repair shops (perhaps searched for within a broader geographical area than the previous example) that possess the tools and/or technicians to perform the repairs.

In still another example, the repair shop service 220 can be used by the AI system in association with information from the parts procurement service 215. In this example, it can first be determined when a replacement part will be available (e.g., delivered to a properly-equipped repair shop in the vicinity of the damaged vehicle) and, based on this approximate delivery time, it can be determined whether a repair shop has availability. In this way, even if a particular repair shop is unavailable for some amount of time (e.g., a week), if a replacement part will not be delivered within this time, then the repair shop could still be used without introducing additional delay for the repairs.

The repair shop service 220 can provide the repair shop availability information for any number of repair shops and is limited only by access to this information from specific repair shops. Repair shops can provide this information to the repair shop service 220 in various ways, e.g., by integrating an internal scheduling system of the repair shop with the repair shop service 220. If a large number of repair shops are integrated with the repair shop service 220, then multiple repair shops can potentially be identified as repair shops that can provide the replacement part.

It should also be understood that the repair shop may also be selected based on other factors that are considered either independently or dependently with the time to repair. For example, each repair shop may be associated with a quality metric that indicates the quality of the repairs performed by the repair shop, e.g., do vehicles need to go back to the repair shop for additional issues after the repair is completed, was the paint blended properly for repairs, were vehicles returned in a clean condition, etc.

Additionally, the repair shop may be selected based on distance of the repair shop to the location of the vehicle, or the residence of the vehicle owner. The repair shop selection decision may be made automatically by the AI system, or it could be made based on human input from vehicle owners, repair shops, insurers etc. The decision may be made automatically based on preferences input by a user independent of the AI evaluations. For example, a car owner may state a preference for the quickest time for repair, as long as the repair shop is within 5 miles. Alternatively, the preferences could be based on a series of rankings of importance of various factors such as time to repair, distance from accident, distance from residence, repair quality ratings, or any other factor which can be measured with respect to the repair process.

Once a repair shop has been selected, the AI system can identify appropriate towing companies in the area, and schedule the vehicle to be towed automatically. Appropriate towing companies could be determined based on considerations of the insurance company involved, the body shop involved, the expected cost for the tow (e.g., is it based on distance of the tow, distance from the tow shop yard, a flat fee, flat fee plus distance), or other factors. The decision regarding the ordering of, and choice of, a tow can be made automatically by the AI system in light of these various considerations, or proposed alternative tow options provided to a human user for final decision. The AI system can be configured to determine based on the information it has received, including the images and any other information, whether the vehicle is drivable, or whether a tow would be required. The final decision as to whether a vehicle can be driven to the repair shop may be made by the user of the vehicle.

Additionally, at the time of scheduling the repairs and establishing a tow, the AI system may be integrated with other services to arrange for a service to transport the driver to a desired location, such as their residence, work, transit hub, car rental agency. Additionally, the AI system could preschedule transportation of a user to the repair facility at the time of expected completion of the repairs.

At various stages of the aforementioned processes, insurance considerations can be used to refine the processes. For example, certain insurers could have pre-established relationships with certain parts vendors and/or repair shops and could have preferences for the repair process in accordance therewith. If multiple repair options are available, insurer preferences can be considered and can override certain efficiencies that could be otherwise achieved. For example, a slightly longer repair time may be preferable if a preferred vendor and/or repair shop can be used if it will improve the overall service to the insured.

The exemplary AI system described above can provide benefits to any interested parties including the vehicle owner, the insurer, and the entities involved in the repair process. In one example, the likelihood of internal damage can be assessed at the first notice of loss (FNOL) stage of the insurance claim process and improve preliminary decisions made regarding the repair (or totaling) of the vehicle. In another example, repair shops can efficiently schedule repair jobs in dependence on the damage assessment and parts procurement timelines, and parts vendors can quickly sell parts available for the vehicle repairs. In still another example, an efficient parts procurement and repair scheduling process can speed the process for completing the repairs. The insurer, the vehicle owner and the repair shop can all benefit from a speedy resolution to the repair process.

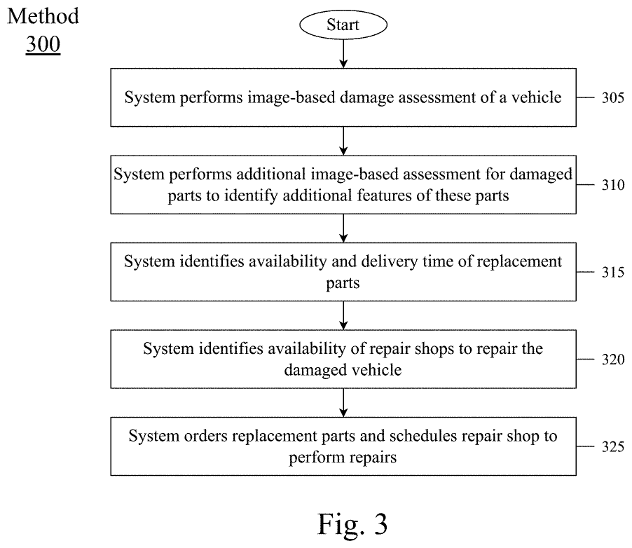

FIG. 3 shows a method 300 for providing a real-time damage estimate and a streamlined repair process using an artificial intelligence (AI) based application according to various exemplary embodiments described herein.

In 305, the AI system performs an image-based damage assessment of a vehicle. As described above, a user can execute an application on a user device that will guide the user to capture images of the vehicle of sufficiently high quality so that the machine learning models can effectively classify the damage incurred by the vehicle. In one embodiment, as described above, one or more machine learning models can be designed so that images of certain pre-identified parts can be used as inputs to determine whether structural damage was suffered.

If it is determined that the vehicle is likely to be totaled, then the method can proceed under the assumption that the vehicle is totaled. In this scenario, any parts procurement and/or repair scheduling processes can be suspended until the vehicle is assessed further by an insurance representative, a repair shop, or a salvage yard. However, if it is determined that the vehicle is unlikely to be totaled, then the method can proceed to streamline the repair process for the vehicle.

In 310, the AI system performs an additional image-based assessment for damaged parts to identify certain additional features of these parts. That is, the vehicle parts that were identified as damaged in 305 (e.g., the “normalized” part) can be further analyzed to determine distinguishing features of the part relative to other features than could be found on the part, e.g., whether sensors, fog lamps, etc., are included on the specific part.

In 315, the AI system identifies the availability and delivery time of replacement parts. As described above, the AI system can use the damaged part feature determination of 310 in association with make/model/year information of the damaged vehicle to identify available parts matching the damaged parts. A parts procurement service can provide information for the availability of the replacement part from various vendors integrated with the service, and an estimated time of delivery for the replacement part from one or more vendors can be determined.

In 320, the AI system identifies the availability of repair shops to repair the damaged vehicle. As described above, the AI system can determine the types of repairs that need to be performed and identify a repair shop that is equipped to perform the repairs. Scheduling information for the repair shops can be used to identify the availability of the shops to perform the repairs. The estimated time of delivery for replacement parts can be used to improve the scheduling of the repairs.

In 325, the AI system orders replacement parts and schedules a repair shop to perform the repairs. This step can include receiving a user selection of these repair process decisions. For example, the AI system can provide to the user a list of repair options via the user device, and the user can select one of the repair options, e.g., the parts vendor or the repair shop to use. The AI system could automatically notify a parts vendor of the parts order and/or a repair shop of the upcoming job. The AI system can further facilitate the necessary communication between the vehicle owner, the repair shop, the parts vendor, and/or the insurer through all stages of the repair process. The damage assessment can be provided to all interested parties, and additional information can be acquired by the user, the insurer, the parts vendor or the repair shop (e.g., additional images or video) in accordance with the procedures of these entities.

Those skilled in the art will understand that the above-described exemplary embodiments may be implemented in any suitable software or hardware configuration or combination thereof. An exemplary hardware platform for implementing the exemplary embodiments may include, for example, an Intel based platform with compatible operating system, a Windows OS, a Mac platform and MAC OS, a mobile device having an operating system such as iOS, Android, etc. The exemplary embodiments of the above-described methods may be embodied as software containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

We claim:

1. A method, comprising:
receiving a series of images of a vehicle from one or more viewpoints;
identifying, for at least a first image from the series of images using a machine learning model, one or more parts of the vehicle captured in the image using a first classifier for identifying parts of the vehicle; and
identifying, for at least the first image, that one of the parts of the one or more parts of the vehicle incurred damage.

2. The method of claim 1, further comprising:
when the one of the parts of the vehicle incurred damage indicative of a repair operation for the one of the parts comprising replacement of the one of the parts, identifying, using the machine learning model, additional features of the one of the parts of the vehicle;
matching the one of the parts and the additional features to a list of available parts provided by a vendor;
determining a replacement part in the list of available parts that corresponds to the one of the parts; and
ordering the replacement part from the vendor.

3. The method of claim 1, further comprising:
receiving repair shop information comprising an availability and capabilities of each of a plurality of repair shops;
selecting one of the plurality of repair shops; and
scheduling repairs for the vehicle at the selected one of the plurality of repair shops.

4. The method of claim 3, wherein selecting the one of the plurality of repair shops comprises:
displaying the plurality of repair shops and the corresponding repair shop information of each repair shop; and
receiving a user selection of one of the repair shops to repair or replace the one of the parts.

5. The method of claim 3, wherein selecting the one of the plurality of repair shops is performed by an artificial intelligence (AI) system based on at least the one of the parts and the repair shop information for each of the plurality of repair shops.

6. The method of claim 5, wherein the repair shop information further comprises an amount of time to repair or replace the one of the parts, wherein the selected one of the repair shops is further based on the amount of time to repair or replace the one of the parts.

7. The method of claim 5, wherein the repair shop information further comprises a quality metric for each repair shop and the selected one of the repair shops is based on the quality metric relative to other ones of the plurality of repair shops, wherein the selected one of the repair shops is further based on the quality metric.

8. The method of claim 4, further comprising:
receiving towing company information for each of a plurality of towing companies; and
selecting one of a plurality of towing companies to tow the vehicle to the selected one of the repair shops.

9. The method of claim 8, wherein selecting the one of the plurality of towing companies comprises:
displaying the plurality of towing companies and the corresponding towing company information; and
receiving a user selection of the selected towing company.

10. The method of claim 8, wherein selecting the one of the plurality of towing companies is performed by an artificial intelligence (AI) system based on at least the towing company information.

11. The method of claim 10, wherein the towing company information comprises one of a distance of the tow, a distance the vehicle is from the towing company, a flat fee for the tow, or a flat fee plus distance charge for the tow.

12. The method of claim 3, wherein scheduling repairs for the vehicle at the selected one of the repair shops is based on at least an estimated delivery time for a replacement part for the one of the parts at the selected one of the repair shops.

13. The method of claim 1, further comprising:
identifying, for at least the first image, a probability of internal damage incurred by the vehicle based on visual indicators determined from the one of the parts.

14. The method of claim 13, further comprising:
when the probability of the internal damage is identified, estimating a cost of repair for the internal damage.

15. The method of claim 14, wherein the cost of repair for the internal damage is a range of values.

16. The method of claim 14, further comprising:
determining, based on at least the cost of repair for the internal damage, whether the vehicle is totaled.

17. The method of claim 13, further comprising:
when the probability of the internal damage is identified, sending an alert indicating the probability of the internal damage, wherein the alert is sent to one of an insurer of the vehicle, a repair shop selected to repair the vehicle or an owner of the vehicle.

18. The method of claim 13, wherein a selecting of a repair shop to repair the vehicle is based on at least the probability of the internal damage.

19. The method of claim 1, further comprising:
when the one of the parts of the vehicle incurred damage, estimating a repair cost for the one of the parts; and
determining, based on at least the repair cost, whether the vehicle is totaled.

20. A system, comprising:
a memory comprising a series of images of a vehicle from one or more viewpoints; and
a processor configured to:
identify, for at least a first image from the series of images using a machine learning model, one or more parts of the vehicle captured in the image using a first classifier for identifying parts of the vehicle;
identify, for at least the first image, that one of the parts of the one or more parts of the vehicle incurred damage;
when the one of the parts of the vehicle incurred damage indicative of a repair operation for the one of the parts comprising replacement of the one of the parts, identify, using the machine learning model, additional features of the one of the parts of the vehicle;
match the one of the parts and the additional features to a list of available parts provided by a vendor;
determine a replacement part in the list of available parts that corresponds to the one of the parts; and
order the replacement part from the vendor.
